(19) United States
(12) Patent Application Publication
(10) Pub. No.: US 2004/0003857 A1
(43) Pub. Date: Jan. 8, 2004

(54) Multilayer agricultural hose and method of manufacturing device therefor

(76) Inventor: Jin-Ho Kim, Chungcheongnam-Do (KR)

Correspondence Address: HAHN LOESER & PARKS, LLP, TWIN OAKS ESTATE, 1225 W. MARKET STREET, AKRON, OH, 44313, US

(21) Appl. No.: 10/381,681

(22) PCT Filed: Oct. 15, 2001
(86) PCT No.: PCT/KR01/01734

(30) Foreign Application Priority Data
Oct. 5, 2001 (KR) 2001/61317

(51) Int. Cl. F16L 11/00

(52) U.S. Cl. 138/125; 138/128; 138/169; 138/170

(57) ABSTRACT

The present invention relates to a multi layer agricultural hose configured to have two layers or three layers, wherein joining surfaces of the hose has an increased adhesive strength required to prevent the joining surfaces from being separated due to a high water pressure, and a manufacturing device therefore. The agricultural hose is formed by laminating layers of tarpaulin obtained by a process where a fabric having polyethylene (HDPE+EVA) as a main component is firstly coated with resin at its external surface and then two fabrics are overlapped and attached by adhesion; and said layers are attached to one another by adhesion, with a joining surface of each of the layers being overlapped in a predetermined length.

### BACKGROUND OF THE INVENTION

(a) Field of the Invention

The present invention relates to a multi layer agricultural hose and manufacturing device thereof, and more particularly, to a multi layer agricultural hose configured to have two layers or three layers, wherein joining surfaces of the hose has an increased adhesive strength required to prevent the joining surfaces from being separated due to a high water pressure, and a manufacturing device thereof.

(b) Description of the Related Art

As prior art agricultural hoses, a hose, disclosed in Korean Utility Model Publication No. 80-1878, having an increased endurance against climate change and an enhanced bending strength, a hose, taught in Korean Utility Model Publication No. 78-129, designed not to allow leakage of water by integrally forming woven fabric with an inner hose made of resin, and a hose, disclosed in Korean Utility Model Application No. 1998-10996, designed to prevent water leakage through pin holes, which may be generated during a manufacturing process of tarpaulin, by attaching a vinyl film on the tarpaulin using adhesion, etc., are well known in the art.

However, although these prior art hoses have several advantages that they have their lives longer than the existing hoses and softness and they can prevent the water leakage through the pin holes formed during manufacturing the tarpaulin, they also have shortcomings in that they have relatively low adhesive strength at their joining surfaces that are joined together after materials of which the hose is made are bent into a circular shape for a shape of the hose, so that the joining surfaces are often separated when a high water pressure is applied and fabrics have a reduced strength if adhesive resin applied on the joining surface is overheated.

Particularly, in case that the prior art hoses listed above are used in tropical regions where there always exist strong ultraviolet rays and agricultural water must be supplied to a place far from the water source, they have a reduced life and the joining surfaces are frequently separated due to their weak adhesive strength when the high water pressure is applied. For these reasons, a tube-like agricultural hose made of PVC is normally used in such tropical regions.

However, since this PVC agricultural hose is made of PVC, the hose cannot be recycled and remains scrapped material after use. Further, the PVC hose has a short service life, thereby causing a frequent replacement. Moreover, the PVC hose has a thick thickness, thereby making it difficult to transfer, keep, and set up it.

### SUMMARY OF THE INVENTION

It is an object of the present invention to provide an agricultural hose having a good endurance against ultraviolet rays, a thin thickness and an increased strength capable of withstanding a high water pressure at its joining surfaces. The inventive agricultural hose may be made via a following process. A softer fiber is firstly prepared by forming minute stripes on a film having a main component of polyethylene (HDPE+EVA) in the fiber making process mixing, then, a fabric having a high density is woven with that fiber, adjusting its tension. Next, tarpaulin is obtained by firstly coating resin on the fabric and attaching two fabrics together with an adhesive. Finally two-layer agricultural hose or three-layer agricultural hose is made using tarpaulin. The inventive multi layer agricultural hose has an increased adhesive strength at its joining surfaces by attaching an outer film of the joining surface to the outer film and attaching an inner film of the joining surface to the inner film, thereby enlarging areas of the joining surfaces.

Another object of the present invention is to provide a device for manufacturing two-layer or three-layer agricultural hose. The two-layer or three-layer agricultural hose may be made via a following process. A softer fiber is firstly prepared by forming minute stripes on a film having a main component of polyethylene (HDPE+EVA) in the fiber making process mixing, then, a fabric having a high density is woven with that fiber, adjusting its tension. Next, tarpaulin is obtained by firstly coating resin on the fabric and attaching two fabrics together with an adhesive. Finally two-layer agricultural hose or three-layer agricultural hose is made using tarpaulin.

To achieve the above and other objects, the present invention provides an agricultural hose characterized in that: said hose is formed by laminating layers of tarpaulin obtained by a process where a fabric having polyethylene (HDPE+EVA) as a main component is firstly coated with resin at its external surface and then two fabrics are overlapped and attached by adhesion; and said layers are attached to one another by adhesion, with a joining surface of each of the layers being overlapped in a predetermined length.

The inventive agricultural hose in accordance with one embodiment of the present invention, is characterized in that said hose includes an outer film made of the tarpaulin coated with the resin and an inner film made of the tarpaulin coated with the resin, wherein said outer film has an outer protrusion whose one part protrudes inward, while the inner film having an inner protrusion whose one part protrudes outward, wherein said outer film and the inner film are attached to each other by resin, with their overlaps being interposed therein, and wherein the protrusion of the outer film is attached to an outer surface of the outer film, while the protrusion of the inner film being attached to an inner surface of the inner film, whereby the agricultural hose has a configuration of two-layers.

The inventive agricultural hose in accordance with another embodiment of the present invention, is characterized in that said hose includes an outer film made of the tarpaulin coated with the resin and an inner film made of the tarpaulin coated with the resin, wherein the outer film has an outer protrusion whose one part protrudes inward, while the inner film having an inner protrusion whose one part protrudes outward, wherein the outer film and the inner film are attached to each other by resin, with their overlaps being interposed therein, and wherein the protrusion of the outer film is attached to an outer surface of the outer film, while the protrusion of the inner film being attached to an inner surface of the inner film; and the hose further includes an outermost film attached to the outer surface of the outer film by resin, wherein both ends of the outermost film are overlapped with each other and their overlapped portion has a same length as those of the inner film and the outer, whereby the agricultural hose has a configuration having three layers.

Further, the present invention provides a device for manufacturing an agricultural hose comprising: pre-heating rollers for previously heating an outer film and an inner film, respectively, which are wound around an outer film roll and an inner film roll, respectively; a first adhesive nozzle for applying resin between the outer film and the inner film which have been pre-heated by the pre-heating rollers, the first adhesive nozzle being movable back and forth; a first pressing roller for joining the outer film and the inner film together by pressing them, between which the resin is applied; a plurality of bending rollers for bending a two-layer fabric having been pressed by the pressing roller into a circular form like a hose; a second adhesive nozzle for applying resin on surfaces of the two-layer fabric to be joined to each other, which has been bent into the circular form by the bending roller, the second adhesive nozzle being movable back and forth; and a second pressing roller for joining the two-layer fabric on which the resin is applied, at its ends by pressing them.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a side elevational view of a device for manufacturing an inventive agricultural hose in accordance with the present invention; and

FIG. 2 is a partially cut-away side elevational view of the inventive device for manufacturing the inventive agricultural hose;

FIG. 3 shows a frontal elevational view of major parts of an adhesive nozzle used in the present invention;

FIG. 4 shows a partially cut-away frontal elevational view of major parts of the adhesive nozzle used in the present invention;

FIG. 5 shows a sectional view of a two-layer agricultural hose in accordance with one embodiment of the present invention;

FIG. 6 illustrates a sectional view of a three-layer agricultural hose in accordance with another embodiment of the present invention; and

FIG. 7 depicts a sectional view of the prior art agricultural hose.

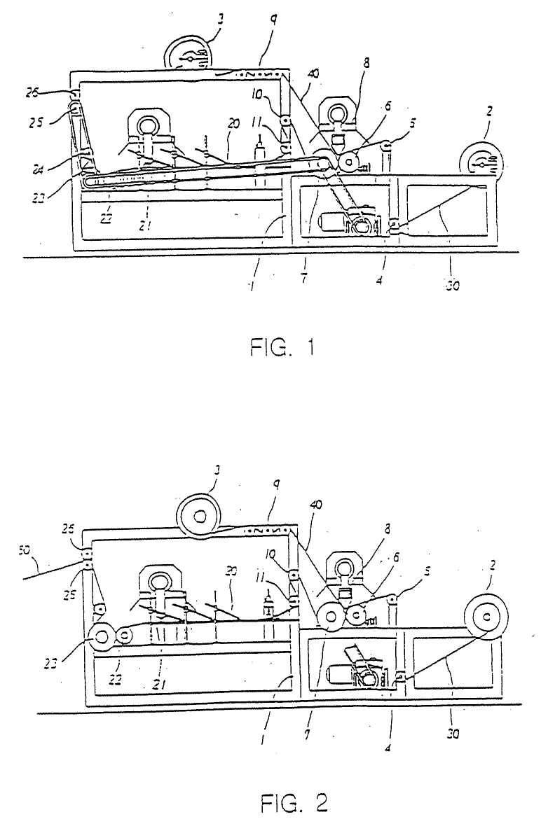

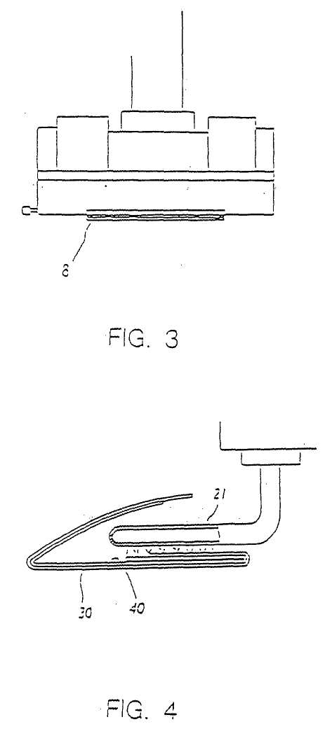

### DETAILED DESCRIPTION OF THE PREFERRED EMBODIMENTS

A preferred embodiment of the inventive multi layer agricultural hose and method for manufacturing the same will hereinafter be described in detail with reference to the accompanying drawings.

In one embodiment of the present invention, an agricultural hose has two-layers. The agricultural hose includes an outer film 30 made of tarpaulin coated with resin and an inner film 40 made of tarpaulin coated with resin. The outer film 30 has an outer protrusion 30b whose one part protrudes inward, while the inner film 40 having an inner protrusion 40a whose one part protrudes outward. The outer film and inner film 30 and 40 are attached to each other by using resin, with their overlaps 30a and 40b being interposed therein. The protrusion 30b of the outer film 30 is attached to an outer surface of the outer film 30, while the protrusion 40a of the inner film 40 being attached to an inner surface of the inner film 40. That is, the agricultural hose has a configuration of two-layers as described above.

Hereunder, a description of a manufacturing process of the above-described two-layer agricultural hose will be made. First, the outer film and the inner film 30 and 40 are prepared by coating an outward portion of the tarpaulin with the resin, wherein the tarpaulin with a constant width is continuously supplied in its lengthwise direction. Then, the inner film 40 is closely attached to an inward portion of the outer film 30 by using the resin, in such a manner that the inner film 40 and the outer film 30 having a same width as that of the inner film 40 are misaligned with each other in their width direction, so that the outer film 30 or the inner film 40 protrudes in the width direction with respect to the adjacent inner film 40 or the adjacent outer film 30 by, e.g., about 2 cm. Finally, when the outer film 30 having the inner film 40 attached thereto is bent into a circular form, one ends of the outer film 30 and the inner film 40 width-wisely misaligned with each other abut on the other ends of the outer film and inner film 30 and 40, respectively and then the overlapped portions are closely attached to each other by using the resin. With this manner, the two-layer agricultural hose 50 is obtained.

In order to provide the outer film 30 with a strength required to endure a great level of water pressure, the outer film 30 is made of a HDPE fabric having 1700 denier or higher, which may be manufactured as following manner. Firstly, a fiber is prepared by mixing a main component of polyethylene (HDPE+EVA) with UV agent. At the moment, in order to obtain a softer fiber, minute stripes are formed on the film in the fiber making process. Then, a fabric having a high density is woven by using that fiber, adjusting its tension. Next, melting and applying a coating material consisting of a main component of polyethylene (LDPE+EVA), which requires a low temperature, with UV agent on both surfaces of the fabric, is performed and then the HDPE fabric having 1700 denier or higher is obtained by finally allowing the fabric to pass between rollers. The inner film 40 is made of the same fabric as that of the outer film 30, in case that it is used in a situation where a higher water pressure is required. However, the inner film 40 is made of a HDPE fabric having a reduced denier number, when it is used in a situation where a relatively low level of water pressure is required. LDPE resin is used in attaching the outer film 30 to the inner film 40.

A manufacturing device for manufacturing the multi layer agricultural hose in accordance with the present invention is provided with an outer film roll 2 and an inner film roll 3 in forms of rolls rotatably mounted in a frame 1, preheating rollers 5 and 9 for previously heating the outer film 30 and the inner film 40, respectively, which are wound around the outer film roll 2 and the inner film roll 3, respectively, a first adhesive nozzle 8 for applying resin between the outer film 30 and the inner film 40 which have been pre-heated by the pre-heating rollers 5 and 9, the first adhesive nozzle 8 being movable back and forth, a plurality of bending rollers 20 for bending into a circular form a two-layer fabric being obtained by pressing and cooling rollers 6 and 7 for joining the outer film 30 and the inner film 40, a second adhesive nozzle 21 for applying resin on one portion of the two-layer fabric bent into the circular form by the bending roller 20, the second adhesive nozzle 21 being movable back and forth, and pressing and drawing rollers 22 and 23 for joining the two-layer fabric on which the resin is applied.

The two-layer agricultural hose in accordance with one embodiment of the present invention has an increased adhesive strength of the joining surface of the hose by attaching the outer film 30 to the outer film 30 and by attaching the inner film 40 to the inner film 40. A manufacturing process of the hose will be described.

In order to manufacture the two-layer agricultural hose, a fabric of which the outer film 30 and the inner film 40 will be made is cut to have a width corresponding to a diameter of a completed two-layer agricultural hose, and then is bent into a roll form.

The outer film 30 obtained by coating the HDPE tarpaulin having a higher denier number with resin is wound around the outer film roll 2 and then is positioned in the frame 1. The outer film 30 wound around the outer film roll 2 is supplied between the pressing roller 6 and the cooling roller 7 through a guiding roller 4 and the pre-heating roller 5.

The reason why the fabrics are previously heated by the pre-heating rollers 5 and 9 before they arrive at a T-die for the joining process, on which the first adhesive nozzle 8 is installed, is that there's a tendency that the fabrics having a lower temperature show a lower adhesive property.

The first adhesive nozzle 8 movable back and forth supplies the adhesive resin to the joining surface of the outer film 30 and the inner film 40 before they pass between the pressing roller 6 and the cooling roller 7.

At the moment, it is possible for the adhesive resin to be flown in its multiple streams or in one main stream.

The outer film 30 is attached to the inner film 40 having the same width as that of the outer film 30, while they being misaligned with each other in their width direction, so that one of the outer film 30 and the inner film 40 laterally protrudes with respect to the other.

The fabric having the two layers of the outer film 30 and the inner film 40 attached thereto is bent or rolled into the circular form having the inner film 40 as its inner layer by the bending roller 20 via guiding rollers 10 and 11.

Since the process where the fabric is rolled into the circular form by several bending rollers 20 is well known in the art, a detailed description about that will be omitted. However, in the present invention, the fabric is rolled in such a manner that the protruding portion of the outer film 30 can be attached to the outer film 30 and the protruding portion of the inner film 40 can be attached to the inner film 40, while the outer film 30 being attached to the inner film 40.

The second adhesive nozzle 21 movable back and forth applies the adhesive resin to the joining surface in such a manner that three streams of the adhesive resin are applied on a portion (a section “a” in FIG. 5) at which the outer film 30 and the inner film 40 meet each other, while two streams of the adhesive resin being applied on a portion (a section “c” in FIG. 5) at which the outer film 30 and the outer film 30 meet each other, and a portion (a section “b” in FIG. 5) at which the inner film 40 and the inner film 40 meet each other, respectively.

The outer film 30 and the inner film 40 applied with the adhesive resin are fully attached to each other by passing between the pressing roller 22 and the drawing roller 23. The completed hose 50 is wound around a conventional hose reel through guiding rollers 24, 25 and 26.

As shown in FIG. 5, the two-layer agricultural hose 50 manufactured in this manner has an increased adhesive strength by attaching the protruding portion of the outer film 30 to the outer film 30 and by attaching the protruding portion of the inner film 40 to the inner film 40, while the outer film 30 being attached to the inner film 40.

In another embodiment of the present invention, a three-layer agricultural hose is shown, which can be obtained by adding an outermost film 110 to the two-layer agricultural hose as described above. The three-layer agricultural hose includes an outer film 120 made of tarpaulin coated with resin and an inner film 130 made of tarpaulin coated with resin. The outer film 120 has an outer protrusion 120b whose one part protrudes inward, while the inner film 130 having an inner protrusion 130a whose one part protrudes outward. The outer film and the inner film 120 and 130 are attached to each other by using resin, with their overlaps 120a and 130b being interposed therein. The protrusion 120b of the outer film 120 is attached to an outer surface of the outer film 120, while the protrusion 130a of the inner film 130 being attached to an inner surface of the inner film 130. An outermost film 110 is attached to the outer surface of the outer film 120 by resin, wherein both ends 110a and 110b of the outermost film 110 are overlapped with each other and their overlapped portion has a same length as those 120a and 130b of the inner film 130 and the outer film 120. With this manner described above, the agricultural hose has a configuration having three layers.

The above-described three-layer agricultural hose can be manufactured by attaching the outermost film 110 on the outer surface of the two-layer agricultural hose described above by using resin. At the moment, both ends 110a and 110b of the outermost film 110 are overlapped with each other and their overlapped portion has a same length as those 120a and 130b of the inner film 130 and the outer film 120.

Since a manufacturing device for manufacturing the three-layer agricultural hose is similar to the manufacturing device for the two-layer agricultural hose, except that it further includes rollers for supplying, pre-heating and transferring the outermost film 110, a detailed description and explanation about that will be cancelled.

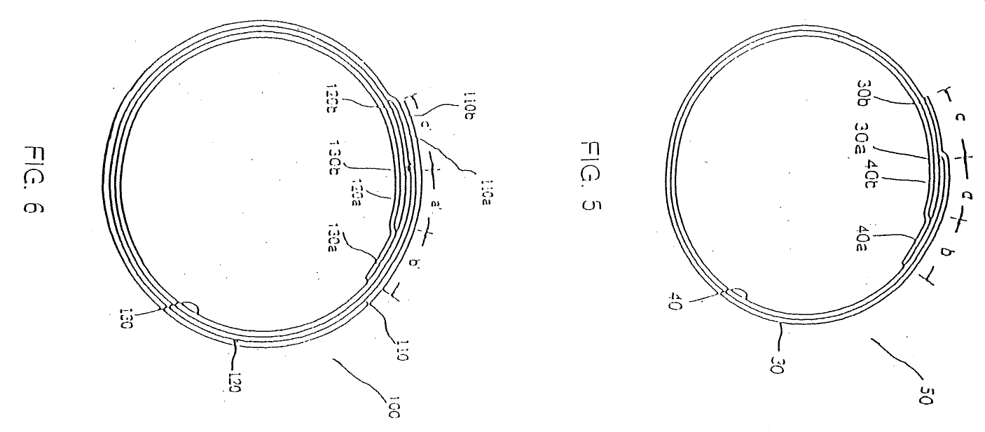

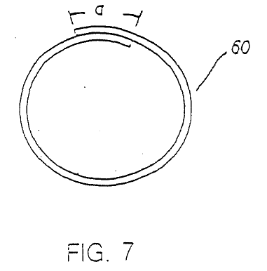

Meanwhile, since, in the prior art hose 60, adhesion is made to only an area a as shown in FIG. 7, whereas, in the inventive multi layer agricultural hoses, adhesions are made to areas b and c in FIG. 5 and areas b′ and c′ in FIG. 6 where the protrusion portions are attached in their overlapped conditions, as well as an area a in FIG. 5 and an area a′ in FIG. 6, the inventive hoses have a very superior adhesive strength. Accordingly, the inventive hoses have their strength not inferior to that of a hose made of PVC.

In tropical regions, hoses being currently used for a supply of agricultural water have been becoming principle causes of an environmental pollution due to their manufacturing process, etc., and most of them are made of PVC due to a strength problem, which can not be used for recycling purposes. However, the inventive agricultural hoses are twice as strong as those PVC hoses in the strength (based on a test; the strength of the PVC hose is about 205.8 kg/5 cm, while a PE hose in accordance with the present invention having a strength of about 411.5 kg/5 cm or 470.4 kg/5 cm) and show good endurance against ultraviolet rays. Furthermore, the inventive hoses can even withstand water pressure above 50 kgf/cm².

Moreover, in comparison of the price, while the price of the PVC hose having a diameter of 4 inch and a length of 100 m being 120,000 KR Won, the price of the inventive hose having a strength higher than that of the PVC hose is 80,000 KR Won and the price of the inventive hose having a strength nearly equal to that of the PVC hose is 60,000 KR Won as a half price of the PVC hose. Accordingly, the inventive hoses have competitiveness with respect to the PVC hose in terms of price or quality. Particularly, since the PVC hose has been becoming a trouble worldwide due to the environmental pollution, the applicant expects that the inventive agricultural hoses will be sold well in a worldwide market.

The multi layer agricultural hose in accordance with the present invention has an increased adhesive strength by improving the joining method of the hose, and an extended life in even an extreme situation such as the tropical region.

Further, since the inventive hose is made of thermoplastic resin that guarantees an absolute recycling use, it may replace the PVC hose normally used in the tropical region causing the environmental pollution, thereby solving the environmental problem.

Moreover, the inventive agricultural hose being currently sold to the tropical region is helpful to increase the national interests and provides the user with convenience when transferring and manipulating it, since its thickness is only as half as that of the PVC hose.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An agricultural hose characterized in that:
said hose is formed by laminating layers of tarpaulin obtained by a process where a fabric having polyethylene (HDPE+EVA) as a main component is firstly coated with resin at its external surface and then two fabrics are overlapped and attached by adhesion; and said layers are attached to one another by adhesion, with a joining surface of each of the layers being overlapped in a predetermined length.

2. The agricultural hose of claim 1, characterized in that said hose includes an outer film made of the tarpaulin coated with the resin and an inner film made of the tarpaulin coated with the resin, wherein said outer film has an outer protrusion whose one part protrudes inward, while the inner film having an inner protrusion whose one part protrudes outward, wherein said outer film and the inner film are attached to each other by resin, with their overlaps being interposed therein, and wherein the protrusion of the outer film is attached to an outer surface of the outer film, while the protrusion of the inner film being attached to an inner surface of the inner film, whereby the agricultural hose has a configuration of two-layers.

3. The agricultural hose of claim 1, characterized in that said hose includes an outer film made of the tarpaulin coated with the resin and an inner film made of the tarpaulin coated with the resin, wherein the outer film has an outer protrusion whose one part protrudes inward, while the inner film having an inner protrusion whose one part protrudes outward, wherein the outer film and the inner film are attached to each other by resin, with their overlaps being interposed therein, and wherein the protrusion of the outer film is attached to an outer surface of the outer film, while the protrusion of the inner film being attached to an inner surface of the inner film; and the hose further includes an outermost film attached to the outer surface of the outer film by resin, wherein both ends of the outermost film are overlapped with each other and their overlapped portion has a same length as those of the inner film and the outer, whereby the agricultural hose has a configuration having three layers.

4. A device for manufacturing an agricultural hose comprising:
pre-heating rollers for previously heating an outer film and an inner film, respectively, which are wound around an outer film roll and an inner film roll, respectively;
a first adhesive nozzle for applying resin between the outer film and the inner film, which have been pre-heated by the pre-heating rollers, the first adhesive nozzle being movable back and forth;
a first pressing roller for joining the outer film and the inner film together by pressing them, between which the resin is applied;
a plurality of bending rollers for bending a two-layer fabric having been pressed by the pressing roller into a circular form like a hose;
a second adhesive nozzle for applying resin on surfaces of the two-layer fabric to be joined to each other, which has been bent into the circular form by the bending roller, the second adhesive nozzle being movable back and forth; and
a second pressing roller for joining the two-layer fabric on which the resin is applied, at its ends by pressing them.

5. The device for manufacturing an agricultural hose of claim 4, wherein said first pressing roller is provided with a cooling roller, rotated by being engaged with the first pressing roller, for cooling the fabric.
